(19) United States
(12) Patent Application Publication
(10) Pub. No.: US 2018/0150486 A1
(43) Pub. Date: May 31, 2018

(54) LINKING DATASETS

(71) Applicants: Rycharde HAWKES, Birstol (GB); Luis Miguel VAQUERO GONZALEZ, Bristol (GB); Lawrence WILCOCK, Bristol (GB); HEWLETT PACKARD ENTERPRISE DEVELOPMENT LP, Houston, TX (US)

(72) Inventors: Rycharde Hawkes, Birstol (GB); Luis Miguel Vaquero Gonzalez, Birstol (GB); Lawrence Wilcok, Birstol (GB)

(21) Appl. No.: 15/577,332

(22) PCT Filed: May 28, 2015
(86) PCT No.: PCT/EP2015/061892

§ 371 Date: Nov. 27, 2017

(51) Int. Cl. G06F 17/30

(52) U.S. Cl. CPC G06F 17/30303; G06F 17/30339; G06F 17/30424; G06F 17/30569

(57) ABSTRACT

A method is described in which a first data set, which is represented by a first model, is provided; a second data set, which is represented by a second model, is provided; information relating to a link to be created between the first data set and the second data set is received; a link creation mechanism is selected based on the received information; an equivalence between the first data set and the second data set is determined using the selected link creation mechanism; an equivalence relation is added to the first model based on the determined equivalence; and an equivalence relation is added to the second model based on the determined equivalence.

### BACKGROUND

Data sets that do not have navigable relationships to each other can be joined by associating objects (entities) in one data set with objects that share a common attribute in the other data set.

### BRIEF DESCRIPTION OF DRAWINGS

Examples will now be described, by way of non-limiting example, with reference to the accompanying drawings, in which:

FIG. 1 is a flowchart of an example of a method of linking two data sets;

FIG. 2 is a flowchart of an example of a method of linking two data sets;

FIG. 3 is an example of a description of a link creation mechanism;

FIG. 4 is a flowchart of an example of a link creation mechanism;

FIG. 5 is an example of a method of linking two data sets;

FIG. 6 is an example of a method of maintaining links between two data sets; and

FIG. 7 is a schematic diagram of an example apparatus for linking two data sets.

### DETAILED DESCRIPTION

Various techniques exist for joining datasets and for enabling querying across joined datasets, including record linkage, relational databases, probabilistic databases, deductive databases, and multiplex graphs. Each of these techniques involves creating a model of each of the data sets to be joined. The term “model” is intended to refer to a simplified representation of the underlying entities in a system, their evolution over time, and their mutual interactions.

Record linkage techniques detect duplicated records in the same table or across different tables of a database. Many of these techniques permit a user to specify similarity functions according to which two items will be flagged as being the same. The rules that govern these similarity functions are usually hardcoded and it is therefore difficult for a non-expert user to adjust the similarity functions.

A probabilistic database consists of: (1) a collection of incomplete relations R, which have missing or uncertain data, and (2) a probability distribution F across all possible complete versions of those relations, also called possible worlds. An incomplete relation is defined over a schema comprising a (non-empty) subset of deterministic attributes that includes all candidate and foreign key attributes in R, and a subset of probabilistic attributes. Deterministic attributes have no uncertainty associated with any of their values, whilst probabilistic attributes may contain missing or uncertain values. The probability distribution F of these missing or uncertain values is represented by a probabilistic graphical model, such as Bayesian Network or Markov Random Field. Each possible database instance is a possible completion of the missing and uncertain data in R. A set of SQL expansions has been proposed to enable a probabilistic database to select the best process to use for creating a join between data sets within a single database management system. These expansions are, however, expressed in a highly imperative manner which makes them difficult for a non-expert user to understand and employ.

A deductive database is a database system that can make deductions (i.e., conclude additional facts) based on rules and facts stored in the deductive database. Deductive databases represent a mix between logic programming languages, such as Prolog, and relational databases. As a result, deductive databases can be queried using declarative language. Joins in a deductive database can be seen as templates that the logic inference process “takes down to earth” and maps to specific actions on the database. As with all database systems, joins in deductive databases comprise merely a result set, and are not part of the data model itself. Consequently, joins are recomputed for every query.

Multiplex graphs are data models which enable joins across graphs to be maintained, because the result of a join becomes part of the data model itself. This facilitates the building of queries that span a multiplex graph (or multiple multiplex graphs). However; the creation of multiplex graphs is a manual process that involves creating multiplex links in an ad hoc manner. A user explicitly models how the links spanning graphs are created and, responsive to changes to the underlying graphs, manually updates these links.

In the following description the term “equivalence” is used to refer to an entity or attribute of an entity in a first data set which is deemed to be the same as an entity or attribute of an entity in a second data set. The criteria used to determine whether entities or attributes are the same can vary, e.g. in dependence on the particular application, user preferences, etc., and thus a given pair of entities/attributes may comprise an equivalence in one example but not in another example.

In the following description the term “high-level” is used to refer to language which is strongly abstracted from the details of the computer or process which the language is being used to describe. A high-level language for the purposes of the specification is therefore to be understood as a query language which does not prescribe a sequence of commands to be followed to create a join, but instead is closer to the way a non-technical user would specify such an action. One example of this may use natural language elements. A high-level language can therefore easily be used without any detailed knowledge of the underlying computer system or process which will run the query.

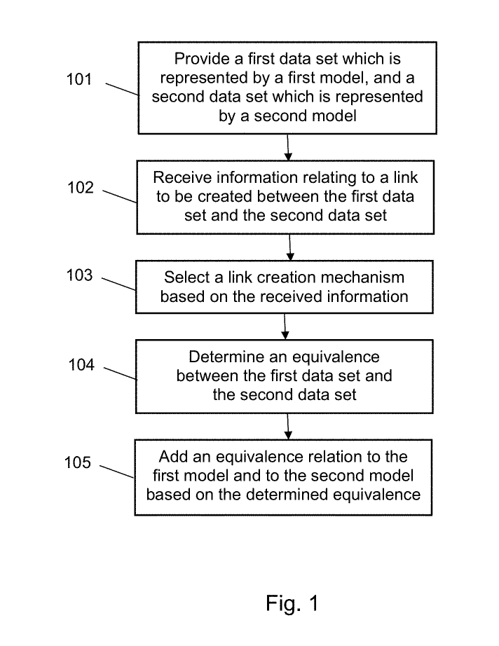

FIG. 1 illustrates an example of a method, e.g. for linking two data sets. In some examples the method is performed by a processor of a computer system. In a first block, 101, a first data set and a second data set are provided, e.g. to the processor. The first data set is represented by a first model and the second data set is represented by a second model. In some examples the first model and the second model comprise multiplex graphs. In some such examples the multiplex graphs are comprised in a multi-partite graph. In a multi-partite graph relations are established between entities of differing types (e.g. cars and car vendors and owners) but are not established between entities of the same type (i.e. meaning that two cars cannot be related). In some examples an entity in a first graph may be equivalent to any of the entities in a different graph. In some examples the first model and the second model comprise tables. The first model is of the same type as the second model.

Then, in block 102, information relating to a link to be created between the first data set and the second data set is received, e.g. by the processor. In some examples the information comprises a declarative query which provides a high-level description of the link to be created. The information may, for example, be in the form of a specification submitted by a user of the computer system. In some examples the information comprises a query written in a high-level, declarative query language. Since the language is declarative, rather than imperative, the information does not need to specify how the link is to be created (e.g. the exact manner in which equivalences between the first and second data sets are to be found).

For example, a declarative query used to specify a particular join could have the form:
Database_url1:company{name,count(business_unit),count(department)}
   By contrast, a classic SQL query specifying the same join would have the form:

SELECT “company”.“name”, COALESCE(“business_unit ”.“count”,
0), COALESCE(“department”.“count”, 0)
FROM “ad”.“company”
LEFT OUTER JOIN (SELECT COUNT(TRUE) AS “count”, “
business_unit ”.“company_code” FROM “ad”.“ business_unit ”
GROUP BY 2) AS “ business_unit ” ON (“company”.“code” = “
business_unit ”.“company_code”)
LEFT OUTER JOIN (SELECT COUNT(TRUE) AS “count”,
“department”.“company_code” FROM “ad”.“department” GROUP BY
2) AS “department” ON (“company”.“code” =
“department”.“company_code”)
ORDER BY “company”.“code” DSC

The declarative language used by examples can provide flow processing abstractions for querying across linked datasets graphs, composable query fragments, and a macro inclusion system. In particular, the examples which use declarative language make nested aggregations and projections of database tables easy to understand and use.

In some examples the received information comprises information identifying the first data set and the second data set. In other words, the information specifies the data sources of the data sets which the user wants to link. These sources can be, for example, graphs, database tables, file repositories, etc. In some such examples the information specifies a hardware provision and a service provision for each data set.

The user can also indicate in the specification information relating to equivalences the user wishes the created link to be based on. Such information can comprise, for example, a type or set of types of entity that the user wishes an equivalence search to be restricted to; a type or set of types of entity that the user wishes to be considered by an equivalence search, an attribute or set of attributes that the user wishes an equivalence search to be restricted to, an attribute or set of attributes that the user wishes to be considered by an equivalence search, and/or a process to be used in an equivalence search (e.g. entropy-based determination of text similarity). Thus, in some examples the received information additionally comprises any or all of: information identifying a type of entity for which equivalences between the data sets to be linked are to be found; information identifying an attribute or a set of attributes for which equivalences between the data sets to be linked are to be found; information identifying transformations on such an attribute or a set of such attributes (e.g. a fast Fourier transform on an attribute carrying signal information); information identifying a process to be used for finding equivalences.

In some examples the user can create a specification by completing a template, where a template is form comprising fields that can be filled in with high-level information (as opposed to programming code or an imperative query, both of which are considered to comprise low-level information for the purposes of this specification). The completion of some of the fields in the template may be optional, such that a user can provide certain kinds of information if the user wishes to specify in more detail how a requested link is to be created, but the link creation process can still proceed without receiving these kinds of information. In some examples, if a field of the template is left blank by the user (i.e. the received information does not contain a certain type of information relating to the link to be created), the processor will consider all possible options relating to that type of information. For example, if a field “entity type” (in which a user can indicate, for example, whether equivalences between text, numbers, or both are to be considered) is left blank, the processor may by default consider both text and numbers when searching for equivalences.

A template can be seen as a static (and often partial) version of the model representing the first and second data sets. A completed template represents the requested status of some of the possible equivalences between the first and second data sets, and the template does not take into account the existence of other possible equivalences. Consider, for example, the declarative query listed in paragraph 19 above:
Database_url1:company{name,count(business_unit),count(department)}
   Formulating this query involves the user specifying the name, the business unit and the department. All other information used by the processor to actually create the join is determined automatically by the processor, using processes such as those described below.

In block 103, a link creation mechanism is selected (e.g. by the processor) based on the received information. In some examples the processor has access to a store of various link creation mechanisms from which the processor may select the most appropriate link creation mechanism for a given received specification. A link creation mechanism can be, for example, a process for finding equivalences between two data sets.

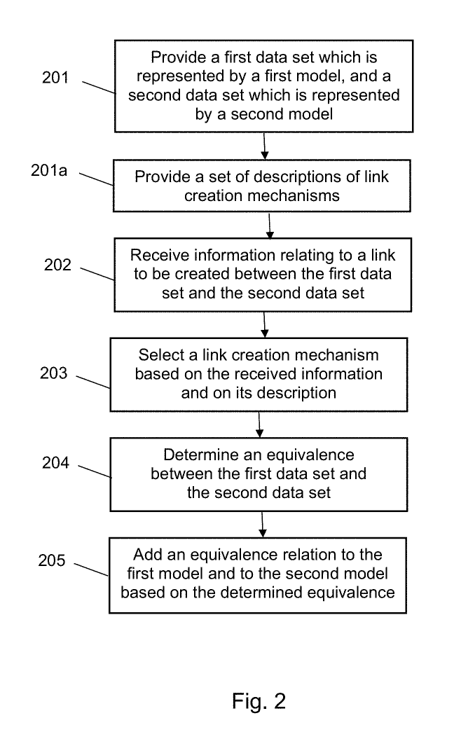

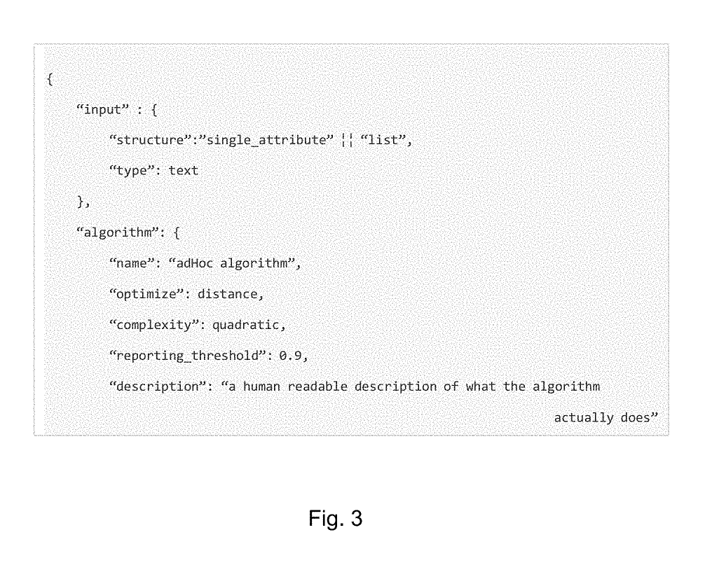

In some examples, the selection of a link creation mechanism is based on a description of that link creation mechanism. FIG. 2 illustrates one such example. Blocks 201, 202, 204 and 205 are performed in the same manner as blocks 101, 102, 104 and 105 of FIG. 1 and will therefore not be described. In block 201a of FIG. 2, a set of descriptions of link creation mechanisms is provided. Each description comprises information about the capabilities of the described link creation mechanism. In some examples each description comprises information about a complexity of the described link creation mechanism. In some examples each description comprises information about a threshold of the described link creation mechanism (e.g. a threshold specifying a minimum probability of a first entity being equivalent to a second entity, in order for the first entity to be deemed by the link creation mechanism to be equivalent to the second entity). FIG. 3 shows an example of a description of a link creation mechanism.

In block 203 a link creation mechanism is selected based on its description as well as on the information received in block 202. In some examples selecting a link creation mechanism comprises, for each description, matching terms in the description with terms in the received information and selecting a link creation mechanism associated with a description having the highest number of matching terms. In some examples in which the provided descriptions comprise information about a complexity and/or a threshold of the described link creation mechanism, selecting a link creation mechanism comprises selecting a link creation mechanism having a relatively lower complexity, and/or a relatively higher threshold, than another link creation mechanism in the set. For example, if several descriptions contain the same number of matching terms, the link creation mechanism having the lowest complexity and/or the highest threshold will be selected from among the link creation mechanisms associated with the descriptions having equal highest numbers of matching terms. If it is not possible to identify a single link creation mechanism meeting predefined selection criteria, in some examples the assistance of a human operator will be sought (e.g. by generating an error message on a display of the computer system).

Thus, the performance of block 203 can be seen as the processor interpreting the descriptions and mapping them to the user provided specification, so as to find the available link creation mechanism that “best” matches what the user indicated in the specification.

Example link creation mechanisms will now be described. In some examples, e.g. examples in which the received information does not comprise any indications as to how the user wishes equivalence relations to be found, or any indications of particular attributes or entities the user wishes to be considered (e.g. the received information is information identifying the first data set and the second data set), a link creation mechanism operates by converting all of the entity attributes in the first data set and all of the entity attributes in the second data set to text. A clustering process based on text similarity is then performed, e.g. by the processor, which generates pairs of attributes (i.e. comprising one attribute from each data set) having a level of text similarity which is greater than a predefined threshold. In some examples this threshold is configurable, e.g. by the user. In some examples the processor presents the generated pairs to the user and requests the user to confirm whether each pair is an equivalence.

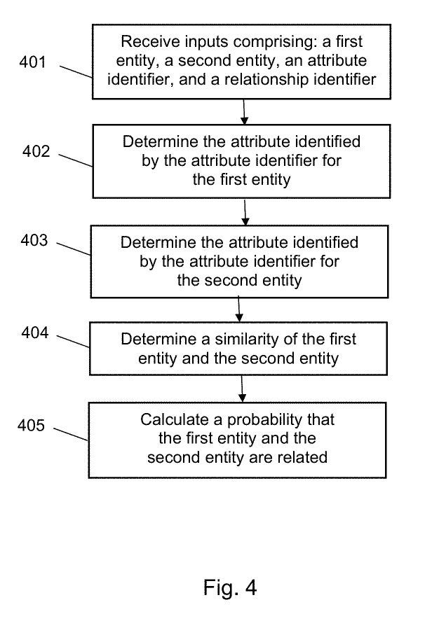

FIG. 4 illustrates the operation of a different example equivalence finding process, e.g. for use by a link creation mechanism. The process of FIG. 4 comprises a lambda function, expressed using functional programming terminology. In a first block 401 the process receives inputs comprising a first entity (e.g. in a first data set), a second entity (e.g. in a second data set), an attribute identifier (e.g. an indication of which attributes of the first and second entity should be compared), and a relationship identifier (e.g. an indication of the type of relationship to be assessed). In some examples the received inputs comprise multiple attribute identifiers and/or relationship identifiers.

In a second block 402 the process determines the attribute identified by the attribute identifier for the first entity, and in a third block 403 the process determines the attribute identified by the attribute identifier for the second entity. Blocks 402 and 403 can be performed in any order, or simultaneously. In examples in which multiple attribute identifiers are input to the process, blocks 402 and 403 are performed in respect of each attribute identified by the input attribute identifiers.

Then, in block 404, the process determines a similarity of the first entity and the second entity by comparing the determined attribute of the first entity with the determined attribute of the second entity. In some examples performing block 404 comprises converting determined attributes to text elements, and comparing the determined attributes comprises determining the similarity of the text elements, e.g. using a clustering process based on text similarity. In some such examples, associations between the attribute and its text elements is stored for a configurable predetermined time period, which can reduce the computational overhead if a further equivalence finding process is performed during the predetermined time period.

In block 405 the process calculates a probability that the first entity and the second entity are related in a manner specified by the input relationship identifier, based on the determined similarity. In examples in which multiple attribute identifiers are input to the process, the similarity determination comprises comparing a pair of determined attributes corresponding to each input attribute identifier, and combining the results of these comparisons. In some examples block 405 comprises comparing a calculated probability to a predefined threshold, wherein a probability less than the threshold will result in the process determining that the first and second entities are not related in the manner specified by the input relationship identifier, and a probability greater than the threshold will result in the process determining that the first and second entities are related in the manner specified by the input relationship identifier.

Returning to FIG. 1, once a link creation mechanism has been selected, in block 104 the selected link creation mechanism is used to determine an equivalence between the first data set and the second data set. The manner in which the equivalence is determined will depend on the details of the link creation mechanism selected. Then, in block 105, an equivalence relation based on the determined equivalence is added to the first model and to the second model. In some examples in which the first and second models comprise multiplex graphs (or different parts of a single global multiplex graph) the equivalence relation comprises an edge. In some examples in which the first and second models comprise tables, the equivalence relation comprises a foreign key. In some such examples, equivalence relations (i.e. foreign keys) are stored in an additional table. Modifying the first and second models in this manner means that a query engine can use the determined equivalences.

The examples therefore provide a simple way for a user to find equivalent entities across multiple data sets. The examples permit the use of a high-level specification language which is accessible to non-experts. Furthermore, since the task of determining how equivalences are to be found can be performed automatically on the basis of a provided high-level specification, equivalences can be found quickly, accurately, and with a little effort on the part of the user.

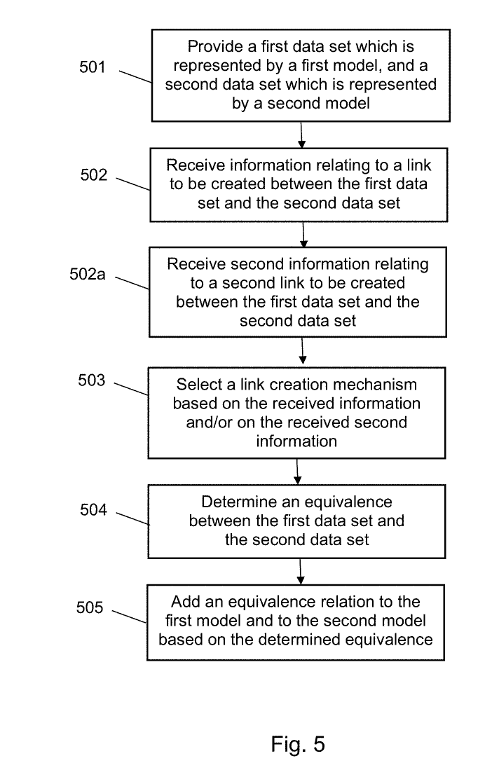

FIG. 5 illustrates an example method, e.g. of linking two data sets, in which two linking requests are processed in parallel. Blocks 501, 502 and 505 are performed in the same manner as blocks 101, 102 and 105 of FIG. 1, and therefore will not be described. In block 502a, second information relating to a second link to be created between the first data set and the second data set is received. The second information may have any or all of the features described above in relation to the received information of FIG. 1. The second information can be input to a computer system by the same user as the received information, or the second information can be input by a different user. The second information may be received before, after, or simultaneously with the information received in block 502. In some examples the second information and the received information are both received within a predefined time period. In other words, information received more than an amount of time equal to the length of the predetermined time period after (or before) the information received in block 502 is not considered to comprise second information. The second information need not be similar to the first information.

In block 503, a link creation mechanism is selected based on the received information and/or on the received second information. In some examples a single link creation mechanism is selected based on the received information and on the received second information. In some examples selecting a link creation mechanism comprises selecting a first link creation mechanism based on the received information and selecting a second link creation mechanism based on the received second information. In some examples performing block 503 comprises comparing terms in a description of an available link creation mechanism to terms in the received information and terms in the received second information, e.g. in the manner described above in relation to block 103 of FIG. 1.

In block 504, each selected link creation mechanism is used to determine an equivalence between the first data set and the second data set, in the manner described above in relation to block 104 of FIG. 1. Depending on the nature of the received information and the received second information, and on how many link creation mechanisms are used, multiple equivalences may be determined. For example, if the received information comprises a specification indicating that a first set of attributes of an entity is to be considered by an equivalence search, and the received second information comprises a specification indicating that a second, different attribute of the same entity is to be considered, equivalences for each attribute will be sought in the performance of block 504.

In some examples a processor performing the example method is to run received specifications in parallel whenever possible. When, in block 505, equivalence relations based on the determined equivalences are added to the first and second models, this can trigger the creation and/or removal of other equivalence relations in the models. In such cases the processor performs blocks 504 and 505 several times. The first pass comprises a parallel processing of all the received information, and subsequent passes comprise an analysis of the entities for which new equivalences were determined in previous passes. In some examples the number of passes after the initial pass is the same as the number of different informations received and processed in parallel (i.e. for the example in FIG. 5, N=2). Determining a new equivalences occurs relatively rarely, so subsequent passes will generally not involve all the entities in the models.

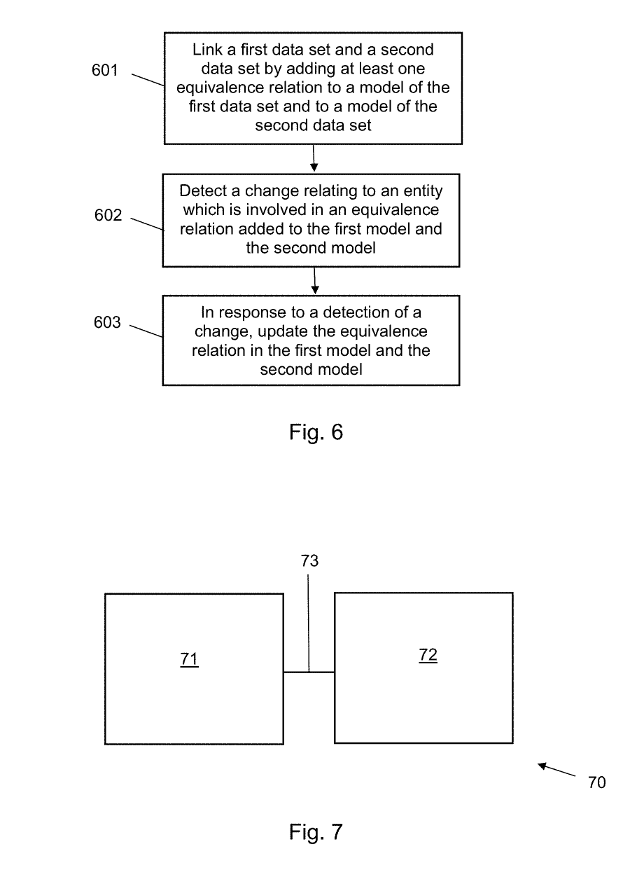

FIG. 6 illustrates an example method, e.g. of maintaining links between two data sets. In a first block, 601, a first data set and a second data set are linked by adding at least one equivalence relation to a model of the first data set and to a model of the second data set. Block 601 may be performed, for example, by performing the method of FIG. 1, the method of FIG. 2, or the method of FIG. 5. Then, in block 602, a change relating to an entity which is involved in an equivalence relation added to the first model and the second model is detected. In some examples detecting a change comprises a receiving process (e.g. of the processor) continuously receiving updated versions of a data set, e.g. from a data source. In some such examples the receiving process is to compare a received updated data set to a current data set and flag any changed entities. In some examples the receiving process is to overwrite a current local copy of an entity with a newly-received changed version of that entity. In some examples the receiving process is to trigger the running of a link creation mechanism to find equivalences involving the changed entities.

In some examples detecting a change comprises creating a watch process, e.g. by the processor of a computer system. In some examples in which the processor comprises a receiving process, the watch process and the receiving process comprise independent execution threads. The watch process may run continuously. In some examples a single watch process is to watch multiple entities, which may be involved in multiple equivalence relations. In some examples the creation of the watch process is based on watch information provided by a user. For example, a user can provide an input indicating an entity or multiple entities, and/or an entity attribute or set of entity attributes, that the user wishes to be observed by a watch process. In some examples the watch information is provided together with information relating to a link to be created between two data sets. In some examples the watch information is provided separately from information relating to a link to be created. In some examples the watch process is to watch all entities which are involved in equivalence relations.

In some examples the watch process is to observe attributes of an entity and to detect when any of these attributes change. A change can comprise, for example, the addition of an entity, the deletion of an entity, or a change in the value of an attribute of an entity (i.e. an update to the entity). In some examples new, deleted and updated entities are handled separately, which simplifies the change detection process and reduces the computational overhead. In some examples the output of the watch process is a list of entities whose “to-be-watched” attributes have changed.

In some examples in which a watch process is provided, the receiving process does not trigger the running of a link creation mechanism to find equivalences involving the changed entities. Such examples reduce the computational burden on the receiving process, enabling updates to the data sets to be processed quickly.

In response to a detection of a change (or multiple changes) relating to an entity involved in an equivalence relation, in block 603 the equivalence relation in which the watched entity is involved is updated in the first model and the second model. In some examples the watched entity may be involved in more than one equivalence relation, in which case block 603 comprises updating each equivalence relation in which the watched entity is involved. In some examples the updating comprises running a link creation mechanism to find new equivalences. Several passes may be necessary, as described above in relation to blocks 504 and 505 of FIG. 5.

FIG. 7 shows an example of an apparatus 70, e.g. for linking two data sets. The apparatus comprises a processor 71 and storage 72 coupled to the processor. The storage 72 can be coupled to the processor 71 by a wired or wireless communications link 73. The storage contains a set of link creation processes, each link creation process in the set being to create a link between a first data set and a second data set. The processor is to receive information relating to a link to be created between a first data set represented by a first model and a second data set represented by a second model. The processor is also to select a link creation process from the set of link creation processes, based on the received information; determine an equivalence between entities or attributes of entities in the first data set and the second data set by running the selected link creation process; add an equivalence relation to the first model based on the determined equivalence; and add an equivalence relation to the second model based on the determined equivalence. In some examples the processor is to perform the method of FIG. 1, the method of FIG. 2, the method of FIG. 5, and/or the method of FIG. 6.

The examples therefore provide systems which enable a user to link two data sets merely by specifying some high-level preferences. The system automatically infers what an equivalence could mean for those data sets, in light of the high-level information provided by the user. Such examples are particularly suitable for non-technical users. Furthermore, in some of the examples equivalence relations created during the link creation process are maintained, enabling them to be used to enrich a result set generated when a user later queries one of the linked data sets. In some examples the equivalence relations are maintained and updated even in the face of changes to the underlying data contained in the linked data sets.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operation steps to produce computer-implemented processing, thus the instructions executed on the computer or other programmable devices provide a step for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
providing a first data set, which is represented by a first model;
providing a second data set, which is represented by a second model;
receiving information relating to a link to be created between the first data set and the second data set;
selecting a link creation mechanism based on the received information;
determining an equivalence between the first data set and the second data set using the selected link creation mechanism;
adding an equivalence relation to the first model based on the determined equivalence; and
adding an equivalence relation to the second model based on the determined equivalence.

2. A method in accordance with claim 1, wherein the first model and the second model comprise multiplex graphs, and wherein the equivalence relation comprises an edge.

3. A method in accordance with claim 1, wherein the first model and the second model comprise tables, and wherein the equivalence relation comprises a foreign key.

4. A method in accordance with claim 1, wherein the received information comprises a declarative query which provides a high-level description of the link to be created.

5. A method in accordance with claim 1, wherein the received information comprises information identifying the first data set and the second data set.

6. A method in accordance with claim 5, wherein the received information comprises any or all of:
information identifying a type of entity for which equivalences between the data sets to be linked are to be found;
information identifying an attribute or set of attributes for which equivalences between the data sets to be linked are to be found;
information identifying a transformation of an attribute or set of attributes for which equivalences between the data sets to be linked are to be found;
information identifying a process to be used for finding equivalences;
information indicating that a watch process should be created to detect changes in an attribute and/or an equivalence relation.

7. A method in accordance with claim 1, wherein the link creation mechanism comprises a process for finding equivalences between two data sets.

8. A method in accordance with claim 7, wherein the process comprises a lambda function to:
receive inputs comprising: a first entity, a second entity, an attribute identifier, and a relationship identifier;
determine the attribute identified by the attribute identifier for the first entity;
determine the attribute identified by the attribute identifier for the second entity;
determine a similarity of the first entity and the second entity by comparing the determined attribute of the first entity with the determined attribute of the second entity; and
calculate a probability that the first entity and the second entity are related in a manner specified by the relationship identifier, based on the determined similarity.

9. A method in accordance with claim 1, comprising providing a set of descriptions of link creation mechanisms, wherein each description in the set comprises information about the capabilities of the described link creation mechanism, and wherein the link creation mechanism is selected additionally based on its description.

10. A method in accordance with claim 9, wherein selecting a link creation mechanism comprises;
for each description, matching terms in the description with terms in the received information; and
selecting a link creation mechanism associated with a description having the highest number of matching terms.

11. A method in accordance with claim 9, wherein each description comprises information about a complexity and/or a threshold of the described link creation mechanism, and wherein selecting a link creation mechanism comprises selecting a link creation mechanism having a relatively lower complexity, and/or a relatively higher threshold, than another link creation mechanism in the set.

12. A method in accordance with claim 1, comprising receiving second information relating to a second link to be created between the first data set and the second data set; wherein the link creation mechanism is selected based on the received information and on the received second information.

13. A method in accordance with claim 1, comprising:
detecting a change relating to an entity which is involved in an equivalence relation added to the first model and the second model; and
in response to a detection of a change relating to an entity which is involved in an equivalence relation, updating the equivalence relation in the first model and the second model.

14. A method in accordance with claim 13, wherein detecting a change comprises creating a watch process to detect a change relating to an entity which is involved in an equivalence relation added to the first model and the second model.

15. An apparatus comprising:
a processor; and
storage coupled to the processor, the storage containing a set of link creation processes, each link creation process in the set being to create a link between a first data set and a second data set;
wherein the processor is to:
receive information relating to a link to be created between a first data set represented by a first model and a second data set represented by a second model;
select a link creation process from the set of link creation processes, based on the received information;
determine an equivalence between entities or attributes of entities in the first data set and the second data set by running the selected link creation process;
add an equivalence relation to the first model based on the determined equivalence; and
add an equivalence relation to the second model based on the determined equivalence.
